(19) United States
(12) Patent Application Publication
(10) Pub. No.: US 2006/0044825 A1
(43) Pub. Date: Mar. 2, 2006

(54) Lamp for vehicle

(75) Inventor: Jong-Yub Sa, Daegu (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: SL LCD Co., Ltd, Kyungsan-si, Kyungsangbuk-do (KR)

(21) Appl. No.: 10/538,128

(22) PCT Filed: Nov. 25, 2003
(86) PCT No.: PCT/KR03/02541

§ 371 Date: Jun. 6, 2005

(30) Foreign Application Priority Data
Dec. 6, 2002 (KR) 1020020077142

(51) Int. Cl. F21V 7/04

(52) U.S. Cl. 362/600

(57) ABSTRACT

The present invention relates to a lamp for a vehicle, wherein light is caused to be incident into a light guide panel from a side surface of the plate-shaped light guide panel, the light is propagated within the light guide panel by means of total reflection and scattered by a scattering pattern formed on a rear surface of the light guide panel so that the light can be radiated to a front surface of the light guide panel, and the light radiated to the front surface is then radiated forward with a predetermined pattern by means of a cover member provided with a lens pattern. A lamp for a vehicle according to the present invention comprises a housing having an opening through which light radiates; a light-transmitting cover member which has a light incidence plane and a light exit plane, and is fixedly installed on the housing to hermetically cover the opening of the housing and provided with a lens pattern formed on the light incidence plane and/or the light exit plane; a plate-shaped light guide panel which has a light incidence plane defined at a side surface thereof to receive light and a light exit plane defined at a front surface thereof to face the cover member and is provided with a scattering pattern for scattering light incident on the light incidence plane thereof toward the light exit plane thereof; a light source installed at a portion adjacent to the light incidence plane of the light guide panel to emit the light to the light incidence plane; and a reflection plate installed on a rear surface of the light guide panel to reflect the light toward a front surface of the light guide panel.

### TECHNICAL FIELD

The present invention relates to a lamp for a vehicle having a light guide panel, which can be used for a headlamp, a fog lamp, a back-up lamp, a clearance lamp, a lamp for illuminating a number plate, a tail lamp, a brake lamp, a turn signal lamp and an emergency flickering lamp mounted to the exterior of a vehicle, or an indoor lamp mounted to the interior of the vehicle. More particularly, the present invention relates to a lamp for a vehicle, wherein light is caused to be incident into a light guide panel from a side surface of the plate-shaped light guide panel, the light is propagated within the light guide panel by means of total reflection and scattered by a scattering pattern formed on a rear surface of the light guide panel so that the light can be radiated to a front surface of the light guide panel, and the light radiated to the front surface is then radiated forward with a predetermined pattern by means of a cover member provided with a lens pattern.

### BACKGROUND ART

As shown in FIG. 18, a conventional lamp for a vehicle comprises a light source 10 for emitting light, and a reflector 20 and a lens 30 for irradiating the light, which has been emitted from the light source, with a predetermined pattern in a predetermined direction. In the conventional lamp for a vehicle, a point light source that emits light through generation of heat from a filament thereof is generally used as the light source 10, and the light source 10 is located at a focus of the reflector having a parabolic surface. Further, the reflector 20 and the lens 30 are properly designed to establish a predetermined light pattern, i.e. desired illuminance distribution and exit angle of light.

In a case where the lamp for a vehicle having such a structure described above is used particularly as a headlamp, the brightness of the lamp and the exit angle of light are strictly restricted. In a case where the lamp is used as a turn signal lamp, a brake lamp, a tail lamp or the like, the lens should have a color suitable for a desired use thereof.

In the conventional lamp for a vehicle, however, if the shape of the lamp is modified according to changes in the design of the vehicle, here is a problem in that a lot of time and costs are required for designing and manufacturing a lamp satisfying desired illuminance distribution. This is because to performance of the lamp depends on the shape of the reflector or lens and thus an external appearance of the lamp cannot be arbitrarily modified, thereby requiring a lot of time and costs in modifying the shape of the reflector or lens.

Further, since the conventional lamp for a vehicle has a structure in which light emitted from to light source is irradiated in a predetermined direction using the reflector, the reflector should be spaced apart by a predetermined distance from the light source. Thus, the volume of the lamp is increased. Accordingly, there is a disadvantage in that the lamp occupies a larger interior space in the vehicle.

In addition, since the conventional lamp achieves illumination using light emitted from a single point light source installed in the vicinity of a focal length of the reflector, there are problems in that peripheral components may be thermally deformed due to heat generated from the concentrated light source, or moisture may be condensed within the lamp due to a large temperature difference between the interior and exterior of the lamp.

### DISCLOSURE OF INVENTION

The present invention is conceived to solve the aforementioned problems. An object of the present invention is to provide a lamp for a vehicle, wherein an external appearance thereof can be easily modified according to changes in the design of the vehicle, a lamp installation space occupied by the lamp in the vehicle can be decreased due to manufacture of the compact lamp, and problems associated with heat generated from a concentrated light source are solved by distributing heat generation of a light source.

Another object of the present invention is to provide a lamp for a vehicle, which has a plurality of light sources so that if one of the light sources is out of order, the lamp can achieve illumination using the remaining light sources.

A further object of the present invention is to provide a lamp for a vehicle, wherein filters having various colors arm provided between a plurality of light sources and a single light guide panel so that light with various colors can be emitted from the light guide panel.

A still further object of the present invention is to provide a lamp for a vehicle, which can emit light with various colors by stacking a plurality of light guide panels and installing filters having different colors on the respective light guide panels.

A lamp for a vehicle according to the present invention comprises a housing having an opening through which light radiates; a light-transmitting cover member which has a light incidence plane and a light exit plane, and is fixedly installed on the housing to hermetically cover the opening of the housing and provided with a lens pattern formed on the light incidence plane and/or the light exit plane so that radiating light can have a predetermined pattern; a plate-shaped light guide panel which is installed within the housing, has a light incidence plane defined at a side surface thereof to receive light and a light exit plane defined at a front surface thereof to face the cover member, and is provided with a scattering pattern for scattering light incident on the light incidence plane thereof toward the light exit plane thereof; a light source installed at a portion adjacent to the light incidence plane of the light guide panel to emit the light to the light incidence plane; and a reflection plate installed on a rear surface of the light guide panel to reflect the light toward a front surface of the light guide panel.

In the lamp of the present invention, the lens pattern formed on the light incidence plane and/or the light exit plane of the cover member may comprise a plurality of grooves each of which has a semicircular cross-section and a predetermined length.

In the lamp of the present invention, the lens pattern formed on the light incidence plane and/or the light exit plane of the cover member may comprise a plurality of protruding half cylinders each of which has a semicircular cross-section and a predetermined length.

In the lamp of the present invention, the lens pattern formed on the light incidence plane and/or the light exit plane of the cover member may comprise a plurality of hemispherical recesses.

In the lamp of the present invention, the lens pattern formed on the light incidence plane and/or the light exit plane of the cover member may comprise a plurality of hemispherical protrusions.

The lamp of the present invention may further comprise a light-transmitting diffuser provided between the cover member and the light guide panel to diffuse the light irradiated from the light exit plane of the light guide panel.

The lamp of the present invention may further comprise a screen plate which takes the shape of a hoop with a predetermined width and is provided between the cover member and the light source along an outer periphery of the cover member so that the light source cannot be viewed through the cover member.

In the lamp of the present invention, a portion of the light incidence plane of the cover member may be formed with a reflection pattern to reflect external light incident on the light exit plane of the cover member.

The lamp of the present invention may further comprise an inverter for supplying electric power to the light source. At this time, the housing may have an inverter-receiving space formed at a portion thereof facing the reflection plate to receive the inverter.

In the lamp of the present invention, the scattering pawn formed on the light guide panel may comprise a plurality of convexo-concave portions formed on a surface thereof opposite to the light exit plane of the light guide panel.

In the lamp of the present invention, the scattering pattern formed on the light guide panel may comprise a plurality of halftone dots printed on a surface thereof opposite to the light exit plane of the light guide panel.

In the lamp of the present invention, the scattering pattern formed on the light guide panel may comprise a plurality of particulates distributed in the light guide panel.

In the lamp of the present invention, the particulates may be bubbles.

In the lamp of the present invention, the light exit plane of the light guide panel may be formed convexly.

According to the present invention, there is provided the compact lamp for a vehicle, wherein the volume of the lamp can be reduced due to the installation of the light source at a side surface of the light guide panel, concentrated heat generation is prevented due to the installation of the light source along the side surface of the light guide panel, and light is irradiated with a desired pattern by forming the scattering pattern according to the shape of the light guide panel.

The lamp of the present invention may further comprise a second light guide panel which has a convex shape and is stacked on to light exit plane of the light guide panel. At this time, an additional light source is installed in the vicinity of a light incidence plane of the stacked second light guide panel.

In the lamp of the present invention, light-transmitting filters having specific colors may be additionally installed between the light incidence planes of the light guide panels and the light sources, respectively.

In the lamp of the present invention, the scattering pattern formed on the light guide panel and a scattering pattern formed on the second light guide panel may be provided at regions that do not overlap each other.

The lamp of the present invention may further comprise a second light guide panel stacked on the light exit plane of the light guide panel. At this time, a second light source may be installed in the vicinity of a light incidence plane of the stacked second light guide panel.

In the lamp of the present invention, the scattering pattern formed on the light guide panel and a scattering pattern formed on the second light guide panel may be formed not to overlap each other.

In the lamp of to present invention, light-transmitting filters having specific colors may be additionally installed between the light incidence planes of the light guide panels and the light sources, respectively.

In the lamp of the preset invention, a portion of the light incidence plane of the cover member may be formed with a reflection pattern to reflect external light incident on the light exit plane of the cover member.

In the lamp of the present invention, a plurality of the light sources may be installed in the vicinity of the light incidence plane of the light guide panel, and light-transmitting filters having specific colors may be additionally provided between the light guide panel and the respective light sources.

According to the present invention, the lamp can be used as a lamp capable of emitting light having a plurality of colors using a single light guide panel by installing the light-transmitting filters having various colors between the plurality of light sources and the light guide panel. In addition, when the plurality of stacked light guide panels are used, it is possible to a compact lamp capable of emitting light having a variety of colors by installing the filters with desired colors between the light sources and the light guide panels, respectively, so that respective layers can represent different colors.

### BRIEF DESCRIPTION OF DRAWINGS

FIG. 1 is an exploded perspective view of a lamp for a vehicle according to an embodiment of the present invention.

FIG. 2 is a sectional view taken along line A-A in FIG. 1.

FIG. 3 is a perspective view of a surface light source assembly with a light guide panel.

FIG. 4 is a sectional view of the surface light source assembly taken along line B-B in FIG. 3.

FIG. 5 is a perspective view showing an embodiment of a scatting pattern of the light guide panel.

FIG. 6 is a schematic sectional view of a lamp for a vehicle according to another embodiment of the present invention.

FIG. 7 is a schematic sectional view of a tamp for a vehicle according to a further embodiment of the present invention.

FIG. 8 is a perspective view of a stacked light guide panel assembly of FIG. 7.

FIG. 9 is a sectional view of an embodiment of the stacked light guide panel taken along line C-C in FIG. 8.

FIG. 10 is a sectional view of another embodiment of the stacked light guide panel taken along line C-C in FIG. 8.

FIG. 11 is a schematic sectional view of a tamp for a vehicle according to a still further embodiment of the present invention.

FIG. 12 is a schematic view of a tamp for a vehicle according to a still further embodiment of the present invention.

FIG. 13 is a schematic view of an embodiment using LEDs as light sources of the lamp for a vehicle.

FIG. 14 is a schematic view showing an installation orientation of an LED light source.

FIG. 15 is a schematic view of an embodiment using an optic fiber as a light source of the lamp for a vehicle.

FIG. 16 is a schematic view showing a state where a rear side reflection pattern is formed on a cover member.

FIG. 17 is a schematic view illustrating an operating principle of the lamp for a vehicle according to the present invention.

FIG. 18 is a schematic view of a conventional lamp for a vehicle.

### EXPLANATION OF REFERENCE NUMERALS FOR DESIGNATING MAIN COMPONENTS IN THE DRAWINGS

| | |
|---|---|
| 100: Housing | 110: Inverter |
| 200: Surface light source assembly | 210: Light guide panel |
| 220: Reflector | 230: Light source |
| 300: Cover member | 310: Lens pattern |
| 400: Diffuser | 500: Screen plate |
| 600: Reflection plate | 700: Reflection film or coating |

### BEST MODE FOR CARRYING OUT THE INVENTION

Hereinafter, preferred embodiments of the present invention will be described in detail with reference to accompanying drawings.

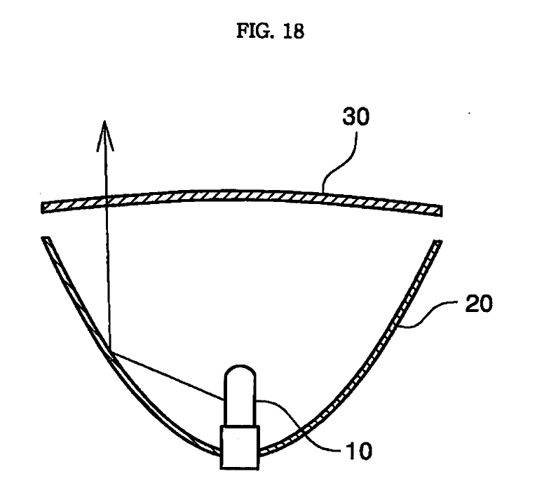

FIG. 17 schematically illustrates an operating principle of a lamp for a vehicle according to the present invention. Light emitted from a light source 230 is incident into a light guide panel 210 through a side surface (light incidence plane) of the light guide panel. The light that travels while being subjected to total reflection within the light guide panel 210 is scattered by a scattering pattern formed on a rear surface of the light guide panel and then exits through a front surface of the light guide panel (light exit plane). The light that exits through the front surface of the light guide panel 210 is irradiated forward with an appropriate pattern through a cover member 300 with a lens pattern formed therein. That is, compared with a conventional lamp for a vehicle as shown in FIG. 18, the lamp using the light guide panel has advantages in that it occupies a smaller space due to the absence of a reflector, concentrated heat generation is prevented due to the distribution of light sources, and an illumination pattern of the lamp can be easily controlled by means of scattering and lens patterns.

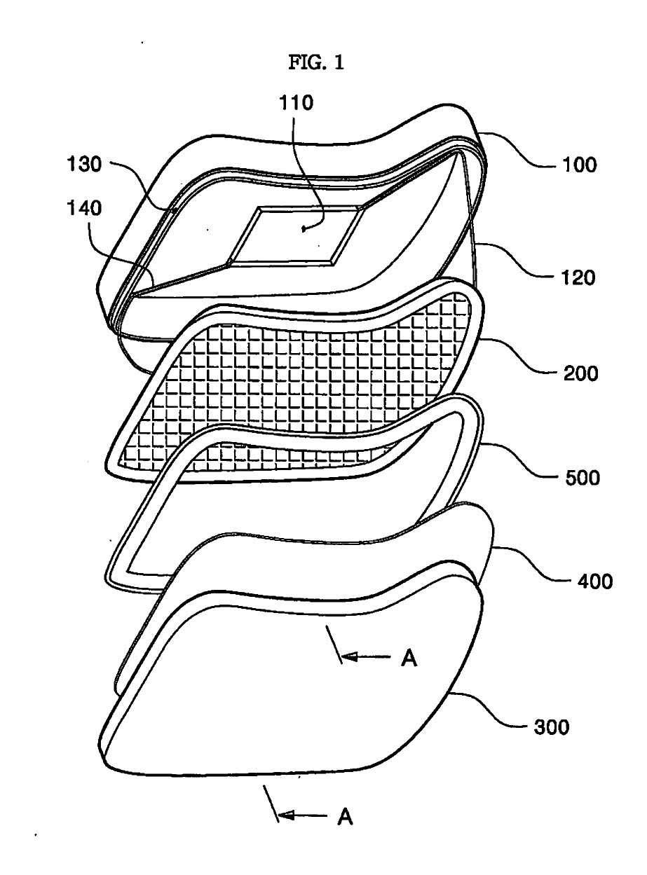

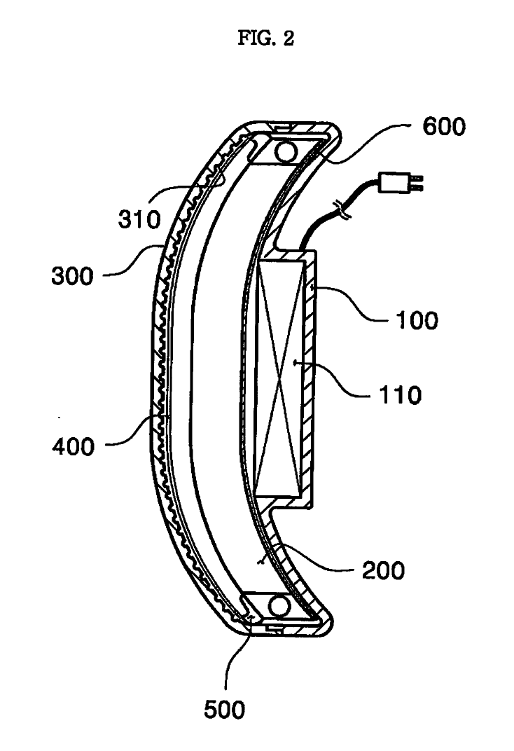

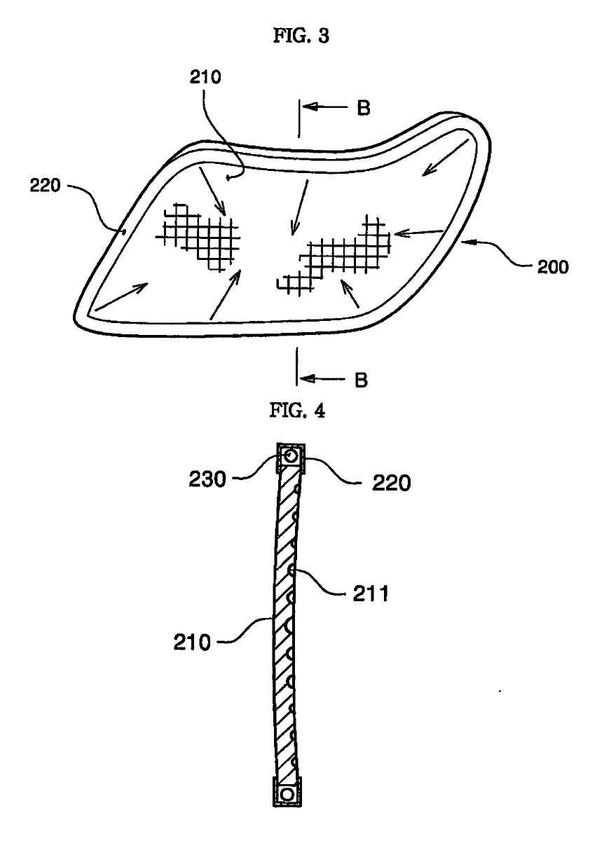

FIG. 1 is an exploded perspective view of a lamp for a vehicle according to an embodiment of the present invention, FIG. 2 is a sectional view taken along line A-A in FIG. 1, FIG. 3 is a perspective view of a surface light source assembly with a light guide panel, and FIG. 4 is a sectional view of the surface light source assembly taken along line B-B in FIG. 3.

As shown in FIG. 1, the lamp of this embodiment comprises a housing 100 having a receiving space defined therein and an opening at one face thereof, a surface light source assembly 200 to be received in the housing 100, a reflection plate 600 attached to a rear surface of the surface light source assembly 200, and a cover member 300 for hermetically covering the opening of the housing.

The housing 100 is made of semitransparent or opaque synthetic resin. Although not shown in the figures, an outer surface of the housing is provided with a supporting structure suitable for installation of the housing at a front or rear portion of a vehicle. The space for receiving the surface light source assembly is defined in the housing, and the opening to which the cover member is attached is formed at a front face of the housing. As shown in FIG. 1, in this embodiment, the housing 100 is provided with a space for receiving an inverter 110 that supplies electric power to alight source 230. However, the inverter may be provided at the exterior of the housing. Further, the housing is formed with a groove 140 for receiving an electric wire 120 through which the electric power is supplied to the light source. Moreover, a step 130 is formed at a periphery of the opening of the housing 100 so that the housing can be hermetically combined with the cover member 300. In addition, instead of the reflection plate, a reflection layer may be coated on or a reflection film may be attached to a bottom surface of the housing 100 to which the surface light source assembly 200 will be mounted.

As shown in FIG. 3, the surface light source assembly 200 comprises a light guide panel 210 taking the shape of an arbitrary plate, the light source 230 installed at a side surface (light incidence plane) of the light guide panel, and a reflector 220 surrounding the light source to cause all light emitted from the light source 230 to be incident on the side surface of the light guide panel. The reflector 220 may be omitted depending on the design of the housing 100. That is, a reflection area that substitutes for the reflector 220 may be formed by means of coating or deposition at a portion of the interior of the housing 100 corresponding to a position where the light source is installed.

The light guide panel 210 is made of acryl or PC based transparent resin. As shown in FIG. 4, a scattering pattern 211 is formed in a rear surface of the light guide panel 210. In the present embodiment, the scattering pattern 211 comprises hemispherically concave halftone dots formed on the rear surface of the light guide panel to establish a convexo-concave configuration. However, it is not limited to such a configuration. The scattering pattern 211 may be formed by performing printing with a solvent ink to melt a resin surface of the light guide panel, by performing printing with ultraviolet-curable resin and curing the resin, or by directly performing machining. Further, the scattering pattern may also be formed by machining the scattering pattern on a surface of a mold and performing plastic injection-molding. Such a scattering patter may be simultaneously formed on the front surface of the light guide panel in addition to the rear surface thereof. Alternatively, the scattering pattern may be formed by injecting light scattering particles or bubbles (air or carbonic acid gas) upon manufacture of the light guide panel. In a case where the lamp is used as a headlamp, the light guide panel 210 is preferably shaped to be flat. In a case where the lamp is used as an indication lamp such as a brake lamp or a turn signal lamp, the light guide panel may be constructed such that a surface thereof from which light exits has a convex shape. If a light exit plane, i.e. the front surface of the light guide panel 210, has a convex shape, the cover member 300 is also constructed to have a convex shape conforming to the convex surface of the light guide panel 210. In this case, since the lamp can be seen well from a side, the lamp is more suitable for the indication lamp. Further, since the light that travels while being subjected to total reflection within the light guide panel 210 leaks out trough the convex surface of the light guide panel 210, it is possible to utilize the radiating light that leaks out without an influence of the scattering pattern, thereby providing a brighter lamp. To render the external appearance of the lamp elegant, some portions of the surface of the light guide panel 210 may have concave shapes and etc other portions thereof may have convex shapes. However, if the area of the concave portions is larger thaw that of the convex portions as a whole, the aforementioned effects can be obtained.

The light source 230 is provided along a side surface of the light guide panel 210. It is preferred that a plurality of light sources 230 be provided to maintain the function of the lamp even though one of the light sources is out of order. Further, a plurality of light sources that emit light with different colors, e.g., red and yellow, may be used so that the lamp can emit light of various colors. In this embodiment, a linear hot or cold cathode tube is used as the light source 230. However, it is possible to use any light sources that can cause light to be incident on a side surface of the light guide panel, such as an LED or optical filer. If a plurality of linear light sources are used in a consecutively arranged state, the light sources 230 do not necessarily surround an entire side surface of the light guide panel 210. A proper number of light sources may be installed to surround only a portion of the side surface of the light guide panel 210 according to a use of the lamp.

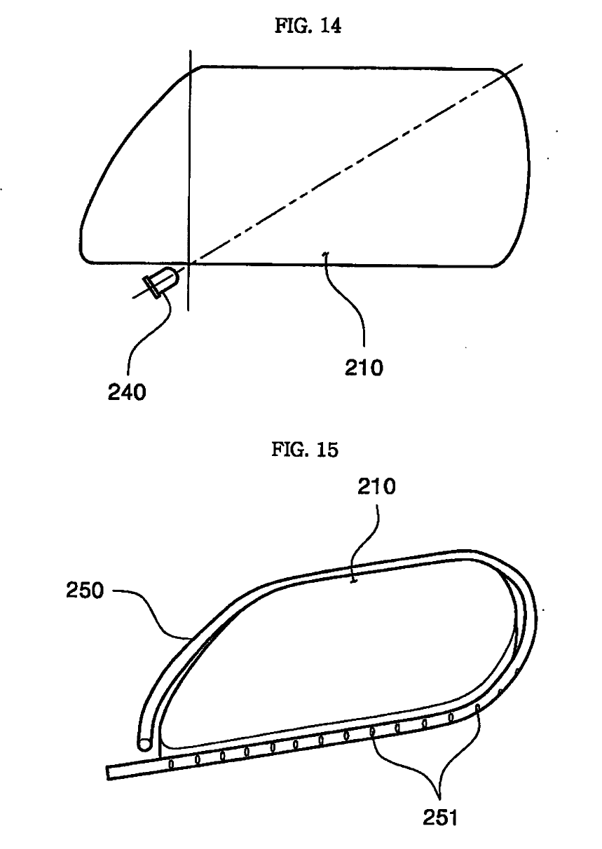

FIG. 13 is a schematic view showing a state where LEDs 240 used as the light sources 230 are installed around side surfaces of the light guide panel 210. In a case where the LEDs 240 are used as the light sources, a socket on which the plurality of LEDs can be simultaneously installed is used to efficiently install them. Further, the plurality of LEDs that emit light with different colors, e.g., red or yellow (orange), are used so that the lamp can emit light of various colors. The plurality of LEDs can be connected to one another in parallel or in series. If the plurality of LEDs are connected in parallel, a compensation circuit is used to apply the same electric current to reeve LEDs so that they can emit light with the same brightness, and to prevent an excessive electric current from flowing into a specific LED. When each of the LEDs 240 is installed at the side surface of the light guide panel the LED is generally installed perpendicularly to the side surface of the light guide panel. However, as shown in FIG. 14, it is preferred that each LED be oriented in a direction in which the distance from a position where the light source is installed to an opposite side surface is largest, so that incident light can be more effectively scattered. Even when a linear light source such as a cold or hot cathode tube is used, in order to obtain the same effects as obtained when the orientation of the LED is changed, a long stripped lens is installed between the light source and the light guide panel to control the direction of the light emitted from the light source so that the light can be irradiated in a direction in which the light incident into the light guide panel can be effectively scattered. Even in a case where an optical fiber is used as the light source, the same method can be employed.

FIG. 15 is a schematic view of an eminent in which a linear optical fiber 250 used as the light source 230 is installed around the side surfaces of the light guide panel 210. In the optical fiber 250 shown in FIG. 15, a scattering pattern 251 is formed at a portion of a periphery of the optical fiber 250 that does not face the light guide panel 210 in order to allow light traveling in a longitudinal direction of the optical fiber therein to be incident on the relevant side surface of the light guide panel 210. Alternatively, a plurality of optical fibers are disposed around the side surfaces of the light guide panel such that ends of the optical fibers face the side surfaces of the light guide panel in a normal direction thereto, thereby enabling light to be incident into the light guide panel. That is, instead of the plurality of LEDs shown in FIG. 13, the plurality of optical fibers are arranged such that the ends thereof face the side surfaces of the light guide panel, thereby obtaining the same effects as obtained when a plurality of point light sources are used. Although not shown in the figures, the plurality of optical fibers may substitute for the light guide panel when they are arranged parallel to one another and scattering patterns are formed on rear surfaces of the optical fibers so that light can radiate uniformly to front surfaces thereof.

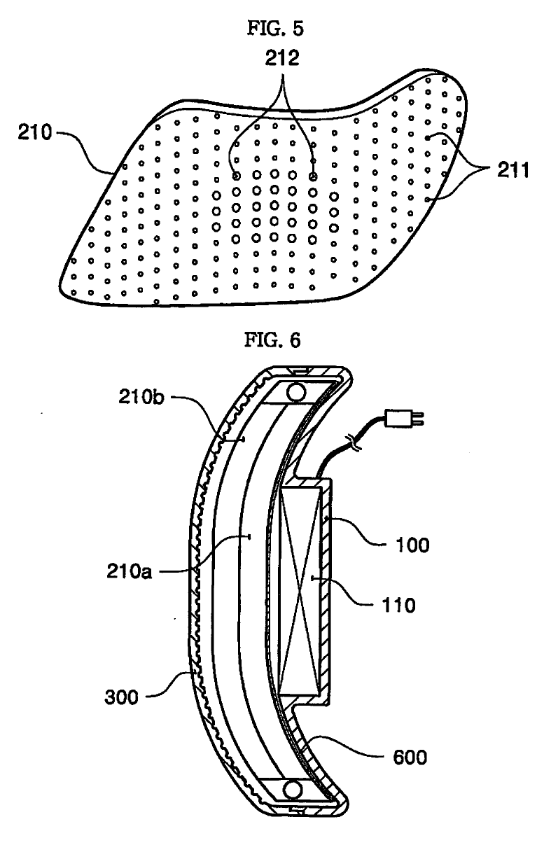

When a linear cold cathode tube as the light source 230 is disposed at the side surface of the light guide panel 210, it is preferred that the linear light source 230 be arranged to be concave toward the interior of the light guide panel 210 so that light to be incident into the light guide panel can overlap with one another as shown in FIG. 3. When the linear light source 230 is arranged to be concave toward the interior of the light guide panel 210, tere is an advantage in that main traveling directions of the light are concentrated on a certain point in the light guide panel. Accordingly, since the amount of radiating light per unit area at the portion on which the light is concentrated increases, it is possible to manufacture a brighter lamp. Further, it is also possible to manufacture a lamp with a predetermined illumination pattern by using difference in brightness of the light guide panel. It will be apparent that such arrangement of the light source is applicable even to a case where a linear light source such as a cold or hot cathode tube, a point light source such as an LED, or an optical fiber is used as the light source. FIG. 5 shows an embodiment of the light guide panel, wherein the size and distribution of halftone dots of a scattering pattern vary depending on positions in the light guide panel so that the lamp can have a predetermined illumination pattern when light overlaps one another at an inner portion of the light guide panel.

If a reflection layer is not coated on or a reflection film is not attached to an inner bottom surface of the housing, the additional reflection plate 600 is disposed between the light guide panel assembly 200 and the inner bottom surface of the housing 100.

The cover member 300 is made of transparent synthetic resin, and a lens pattern 310 is formed on a rear surface (light incidence plane) of the cover member 300. The lens pattern 310 may be formed on a front surface (light exit plane) of the cover member. The cover member 300 functions not only to direct light, which has been irradiated to the light exit plane of the light guide panel in a desired direction by means of the lens pattern 310 formed on the front surface thereof but also to protect the light guide panel. Further, the lens pattern 310 also functions to prevent the scatting pattern of the light guide panel from being viewed from the outside. When the lamp is not used as a headlamp, it is preferred that the cover member 300 be made of colored synthetic resin. The cover member may reflect external light irradiated onto the lamp by attaching a film having light transmissivity of 30% or more to the light incidence plane or by coating a reflection layer (a mirror layer) on the light incidence plane. The lens pattern 310 may be configured by forming a plurality of grooves each of which has a semicircular cross-section and a predetermined length on the light incidence plane or the light exit plane of the cover member. Alternatively, the lens pattern can be configured by forming a plurality of protruding half cylinders each of which has a semicircular cross-section and a predetermined length, by forming a plurality of hemispherical recesses, or by forming a plurality of hemispherical protrusions, on the light incidence plane or the light exit plane.

According to a use of the lamp for a vehicle, a diffuser 400 or a prism plate 400 may be optionally provided between the front surface of the light guide panel and the rear surface of the cover member. The diffuser 400 functions to diffuse light so that the scattering pattern of the light guide panel cannot be viewed. The prism plate 400 is a plate comprising small prisms and serves as a lens for changing the angle of radiating light.

According to a use of the lamp for a vehicle, a screen plate 500 may be optionally provided between the diffuser 400 or the cover member 300 and the light guide panel 200. The screen plate 500 screens the light source 230 and reflector 220 installed around the light guide panel 210 so that they cannot be viewed from the outside. As shown in FIG. 1, the screen plate 500 takes the shape of a hoop with a predetermined width and thickness.

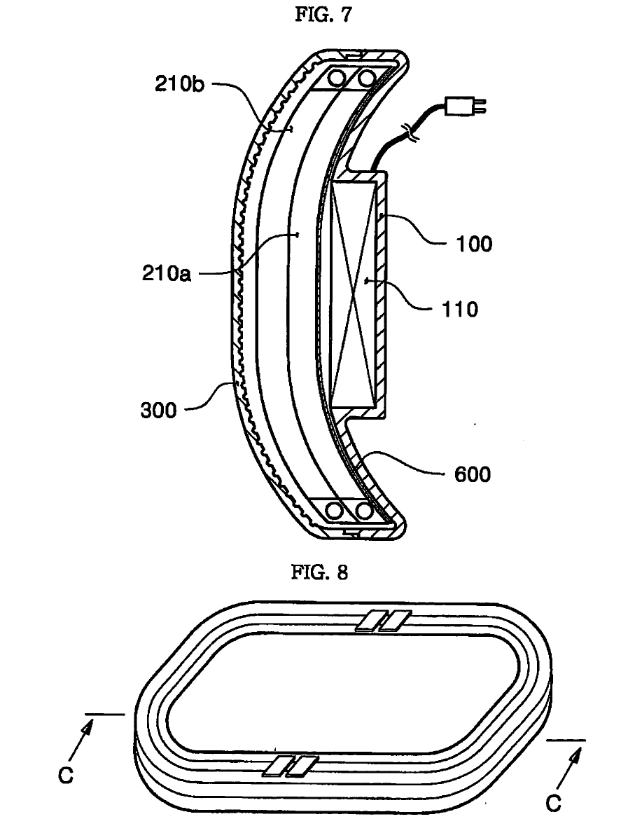

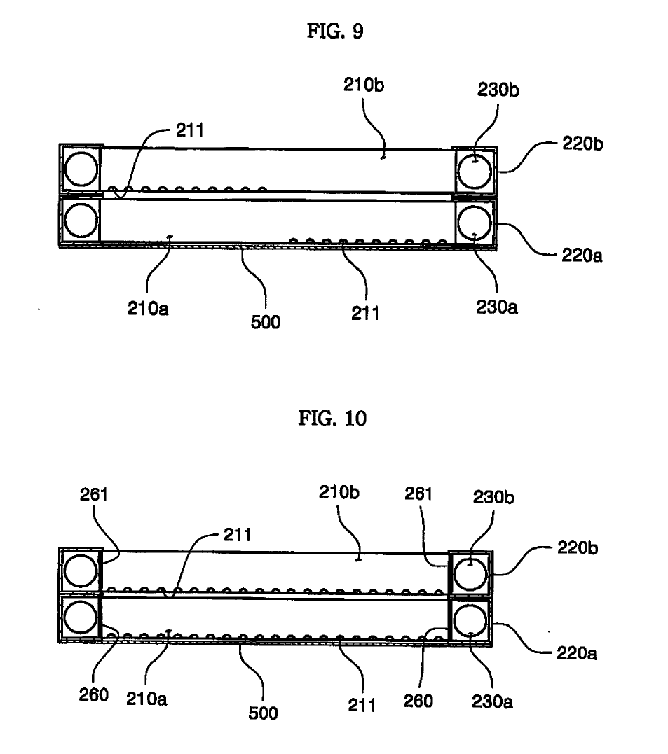

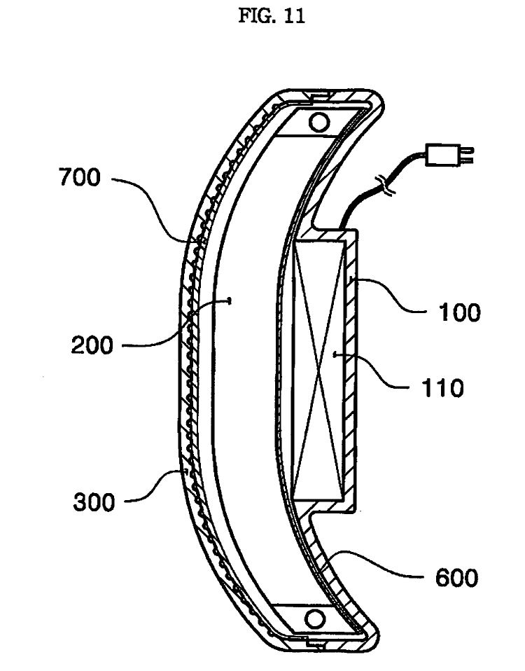

FIG. 6 is a schematic sectional view of a lamp for a vehicle according to another embodiment of the present invention, FIG. 7 is a schematic sectional view of a lamp for a vehicle according to a further embodiment of the present invention, FIG. 8 is a perspective view of a stacked light guide panel assembly of FIG. 7, FIG. 9 is a sectional view of an embodiment of the stacked light guide panel taken along line CC in FIG. 8, and FIG. 10 is a sectional view of another embodiment of the stacked light guide panel taken along line C-C in FIG. 8.

The embodiment shown in FIGS. 6 to 10 is characterized in that a plurality of light guide panels are stacked. The scattering pattern may be formed on each of the stacked light guide panels 210a and 210b, or only on the lower light guide panel 210a. When the scattering pattern is formed on each of the light guide panels as shown in FIG. 9, the scattering pattern of the upper light guide panel 210b may be formed not to overlap with that of the lower light guide panel 210a. Further, the light source 230 may be installed such that light emitted from the light source is incident into both the stacked light guide panels as shown in FIG. 6, or light sources may be independently installed at each of the upper and lower light guide panels as shown in FIG. 7. In the stacked light guide panel assembly shown in FIG. 8, light sources are independently installed at each of the upper and lower light guide panels, and two linear cold cathode tubes are used for each light guide panel. At this time, as shown in FIG. 10, light-transmitting filters 260 and 261 with specific colors may be installed between light incidence planes of the light guide panels 210 and 210b and the light sources 230a and 230b, respectively. When the lamp for a vehicle, which has the stacked light guide panels of this embodiment, is used as a headlamp, a fog lamp, a back-up lamp, a clearance lamp, a lamp for illuminating a member plate, a tail lamp, a brake lamp, a turn signal lamp, an emergency flickering lamp or the like, each of the light sources can be operated independently. Thus, signals with various colors can be displayed by a single lamp for a vehicle, and the brightness of illumination can also be controlled.

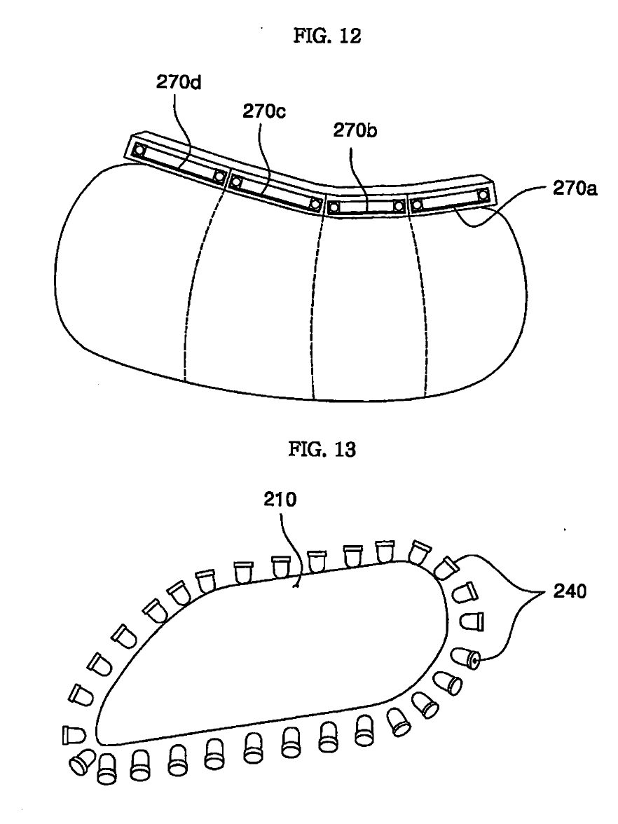

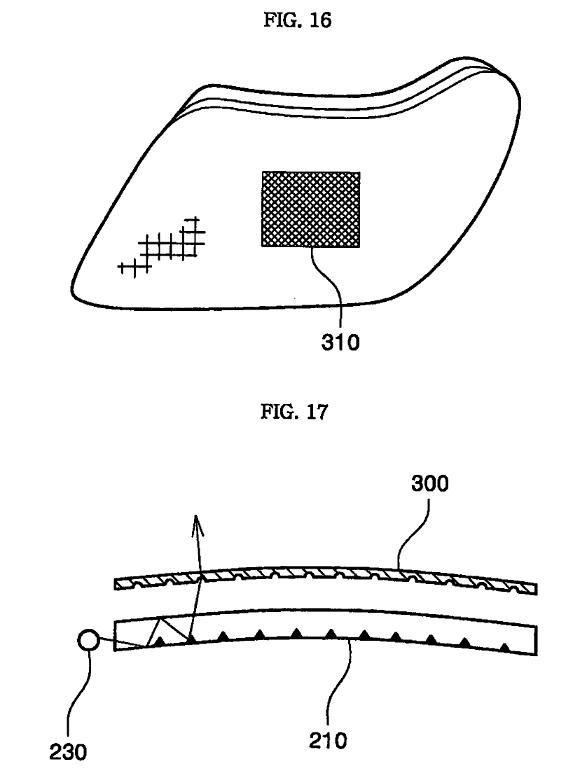

FIG. 11 is a schematic sectional view of a tamp for a vehicle according to a still further embodiment of the present invention, FIG. 12 is a schematic view of a lamp for a vehicle according to a still further embodiment of the present invention, and FIG. 16 is a schematic view showing a state where a rear side reflection pattern is formed on a cover member.

The embodiment shown in FIG. 11 is characterize in that a reflection film is additionally provided on the rear surface of the cover member. That is, there are advantages in that when external light is irradiated onto the lamp, the light is reflected by the reflection film so that a vehicle with the lamp installed thereon can be easily identified and its external appearance can be improved.

The embodiment shown in FIG. 12 is characterized in that a plurality of lamps are installed on a single light guide panel and light-transmitting filters 270a, 270b, 270c and 270d having different colors are placed between the lamps and the light guide plate. Accordingly, there is an advantage in that various colors can be displayed by a single lamp.

The embodiment shown in FIG. 16 is characterized in that a rear side reflection pattern 310 is formed on a light incidence plane or light exit plane of the cover member. As shown in FIG. 16, when external light is irradiated onto the lamp, the light is reflected by the reflection pattern formed on a portion (or entire portion, if necessary) of the lens of the cover member so that a vehicle can be easily identified and its external appearance can be improved.

### INDUSTRIAL APPLICABILITY

According to the present invention, there is provided a lamp for a vehicle, wherein an external appearance thereof can be easily modified according to changes in the design of the vehicle, a lamp installation space occupied by the lamp in the vehicle can be decreased due to manufacture of the compact lamp, and heat generation of a light source is distributed to prevent generation of condensate due to concentrated heat generation of a light source.

According to the present invention, there is provided a reliable lamp for a vehicle, which has a plurality of light sources so that if one of the light sources is out of order, the lamp can achieve illumination using the remaining light sources.

In addition, according to the present invention, there is provided a lamp for a vehicle, wherein filters having various colors are provided between a plurality of light sources and a single light guide panel so that light with various colors can be emitted from the light guide panel, and a lamp for a vehicle, which can emit light with various colors by stacking a plurality of light guide panels and installing filters having different colors on the respective light guide panels, thereby representing various indications by means of a single lamp.

It is intended that the embodiments of the present invention described above and illustrated in the drawings should not be construed as limiting the technical spirit of the present invention. The scope of the present invention is defined only by the appended claims. Those skilled in the art can make various changes and modifications thereto without departing from its true spirit. Therefore, various changes and modifications obvious to those skilled in the art will fall within the scope of the present invention.

1. A lamp for a vehicle, comprising:
a housing having an opening through which light radiates;
a light-transmitting cover member which has a light incidence plane and a light exit plane, and is fixedly installed on the housing to hermetically cover the opening of the housing and provided with a lens pattern formed on the light incidence plane and/or the light exit plane so that radiating light can have a predetermined pattern;
a plate-shaped light guide panel which is installed within the housing, has a light incidence plane defined at a side surface thereof to receive light and a light exit plane defined at a front surface thereof to face the cover member, and is provided with a scattering pattern for scattering light incident on the light incidence plane toward the light exit plane;
a light source installed adjacent to the light incidence plane of the light guide panel to emit light to the light incidence plane of the light guide panel; and
a reflection plate installed on a rear surface of the light guide panel to reflect light toward the light exit plane of the light guide panel.

2. The lamp according to claim 1, wherein the lens pattern formed on the light incidence plane and/or the light exit plane of the cover member comprises a plurality of grooves each of which has a semicircular cross-section and a predetermined length.

3. The lamp according to claim 1, wherein the lens pattern formed on the light incidence plane and/or the light exit plane of the cover member comprises a plurality of protruding half cylinders each of which has a semicircular cross-section and a predetermined length.

4. The lamp according to claim 1, wherein the lens pattern formed on the light incidence plane and/or the light exit plane of the cover member comprises a plurality of hemispherical recesses.

5. The lamp according to claim 1, wherein the lens pattern formed on the light incidence plane and/or the light exit plane of the cover member comprises a plurality of hemispherical protrusions.

6. The lamp according to claim 1, further comprising:
a light-transmitting diffuser provided between the cover member and the light guide panel to diffuse the light irradiated from the light exit plane of the light guide panel.

7. The lamp according to claim 1, further comprising:
a screen plate which takes the shape of a hoop with a predetermined width and is provided between the cover member and the light source along an outer periphery of the cover member so that the light source cannot be viewed through the cover member.

8. The lamp according to claim 1, wherein a portion of the light incidence plane of the cover member is formed with a reflection pattern to reflect external light incident on the light exit plane of the cover member.

9. The lamp according to claim 1, further comprising:
an inverter for supplying electric power to the light source, wherein the housing has an inverter-receiving space formed at a portion thereof facing the reflection plate to receive the inverter.

10. The lamp according to claim 1, wherein the scattering pattern formed on the light guide panel comprises a plurality of convexo-concave portions formed on a surface thereof opposite to the light exit plane of the light guide panel.

11. The lamp according to claim 1, wherein the scattering pattern formed on the light guide panel comprises a plurality of dots printed on a surface thereof opposite to the light exit plane of the light guide panel.

12. The lamp according to claim 1, wherein the scattering pattern formed on the light guide panel comprises a plurality of particulates distributed in the light guide panel.

13. The lamp according to claim 12, wherein the particulates are bubbles.

14. The lamp according to claim 1, wherein the light exit plane of the light guide panel is formed convexly.

15. The lamp according to claim 14, further comprising:
a second light guide panel which has a convex shape and is stacked on the light exit plane of the light guide panel, wherein an additional light source is installed in the vicinity of a light incidence plane of the stacked second light guide panel.

16. The lamp according to claims 15, wherein light-transmitting filters having specific colors are additionally installed between the light incidence planes of the light guide panels and the light sources, respectively.

17. The lamp according to claim 15, wherein the scattering pattern formed on the light guide panel and a scattering pattern formed on the second light guide panel are provided at regions that do not overlap each other.

18. The lamp according to claim 1, further comprising:
a second light guide panel stacked on the light exit plane of the light guide panel, wherein a second light source is installed in the vicinity of a light incidence plane of the stacked second light guide panel.

19. The lamp according to claim 18, wherein the scattering pattern formed on the light guide panel and a scattering pattern formed on the second light guide panel are formed not to overlap each other.

20. The lamp according to claim 18, wherein light-transmitting filters having specific colors are additionally installed between the light incidence planes of the light guide panels and the light sources, respectively.

21. The lamp according to claim 19, wherein light-transmitting filters having specific colors are additionally installed between the light incidence planes of the light guide panels and the light sources, respectively.

22. The lamp according to claim 20, wherein a portion of the light incidence plane of the cover member is formed with a reflection pattern to reflect external light incident on the light exit plane of the cover member.

23. The lamp according to claim 1, wherein a plurality of the light sources are installed in the vicinity of the light incidence plane of the light guide panel, and light-transmitting filters having specific colors are additionally provided between the light guide panel and the respective light sources.
